(19) United States
(12) Patent Application Publication
(10) Pub. No.: US 2017/0359434 A1
(43) Pub. Date: Dec. 14, 2017

(54) WEB CACHING WITH IMAGE AND LOCAL STORAGE

(71) Applicant: Microsoft Technology Licensing, LLC, Redmond, WA (US)

(72) Inventor: Patrick Desjardins, Redmond, WA (US)

(21) Appl. No.: 15/181,510

(22) Filed: Jun. 14, 2016

(51) Int. Cl. H04L 29/08; G06F 17/22

(52) U.S. Cl. CPC H04L 67/2842; G06F 17/2247; G06F 17/227; G06F 17/2205; H04L 67/02

(57) ABSTRACT

The most recent markup language output of content can be cached as an image in client side storage, while loading more current information from a server. Web page information from the server can be rendering using a markup language element. A graphical representation of the user interface at a specific time of a web page or portion thereof can be converted to a string of characters and stored in local storage on the client. The stored image can be presented to the user on a subsequent fetching of web page information from the server based on the last fetched information from the server and the outdated stored image can be replaced with a newly captured graphical representation of the user interface at a specific time to keep the storage as fresh as possible.

A browser is a software application that can receive information from another device on a network such as but not limited to the World Wide Web. A browser can retrieve information and present the retrieved information on a display device. Information resources are identified by a Uniform Resource Identifier (URI) also sometimes called a Uniform Resource Locator (URL). An information resource can be a web page, an image, a video or any other content item. Hyperlinks present in resources enable users to navigate to other resources.

HyperText Markup Language, (HTML), is currently the standard markup language used to create web pages. HTML and its derivatives (XHTML, XML, etc.) are used to create web pages, and to create user interfaces to access web pages and web applications. Web browsers can read HTML files and can render them into visible web pages. HTML describes the structure of a website semantically. HTML can also include instructions that control how the webpage appears (the presentation) for the presentation (appearance) of the web page, thus making HTML a markup language, rather than a programming language. In HTML5 a <canvas> element can be used to draw graphics, on the fly (dynamically), via scripting (usually using JavaScript). The <canvas> element is a container for graphics. A script is used to actually draw the graphics inside the <canvas> element. Canvas provides the ability to draw paths, boxes, circles, and text and to add images.

### SUMMARY

Elements of a markup language for webpages, such as but not limited to HTML5's canvas element can be cached on the client device so that subsequent access is almost instantaneous. A stored image can be used as a placeholder until information from a subsequent request is available.

Once the image is stored on the client, access is very fast (in some circumstances under 5 milliseconds) and can be displayed to the user almost instantaneously. No advanced logic is needed to handle data and the rendering of the data. Using capabilities available in a markup language such as but not limited to HTML5 Canvas, content can come as an image. The user sees what he saw previously and thus can act while more current information is loading. The “time to read” is almost instantaneous.

The most recent markup language output of content can be cached as an image in client side storage, while loading more current information from a server. Web page information from the server can be rendering using a markup language element. A graphical representation of the user interface at a specific time of a web page or portion thereof can be converted to a string of characters and stored in local storage on the client. The stored image can be presented to the user on a subsequent fetching of web page information from the server based on the last fetched information from the server and the outdated stored image can be replaced with a newly captured graphical representation of the user interface at a specific time to keep the storage as fresh as possible.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1 is a block diagram 100 representing web caching in accordance with aspects of the subject matter described herein;

FIG. 2a illustrates an example 200 of web caching in accordance with aspects of the subject matter described herein;

FIG. 2b is an example of pseudo code in accordance with aspects of the subject matter described herein; and

FIG. 3 is a block diagram of an example of a computing environment in accordance with aspects of the subject matter described herein.

### DETAILED DESCRIPTION

### Overview

When a user navigates to a location on a network, such as but not limited to the World Wide Web, typically a loading animation or throbber (also called a spinner) is displayed while an HTTP request is made to a server and information from the server is downloaded. A throbber is an animated graphical control element typically used to show that a computer program is performing an action in the background (such as downloading content, conducting intensive calculations or communicating with an external device). Unlike a progress bar, a throbber does not indicate how much of the action has been completed. A throbber can take various forms and may be associated with a brand or may be a logo of an enterprise associated with the program that is running A throbber can be a still image (known as the resting frame of the throbber) that, when the program is performing an action, animates to let the user know that the program is working. Once the action is complete, the throbber returns to its resting frame.

One disadvantage of displaying the loading animation is that the user cannot interact with the program until data is computed at the server device and is received at the client device. Then the data is processed by the browser (e.g., HTML code is executed). This can take a considerable amount of time. For example, data that comes from a large database can take several seconds to 30 seconds or more to be received at the client device. In accordance with aspects of the subject matter described herein, a user can see previous information received from the server by looking at an image created from what is displayed on the screen (e.g., the loading animation, throbber or spinner). The image can comprise a graphical representation of the user interface at a specific time. Instead of seeing a meaningless throbber which does not display actual data, a graphical representation of an actual previous result can be displayed. Some known solutions may cache previously downloaded information. However, if the website code changed since the last caching operation, out-of-date data can be processed by new code that renders the data into what is displayed on a display device (e.g., on a screen). This can cause disparity between versions and the data may not display correctly.

In accordance with aspects of the subject matter described herein, the cached data retrieved from memory can be displayed as it was displayed with the old rendering code. That is, the data will be displayed as it was displayed when the data was originally downloaded and as it was displayed when the data was acted upon by the code in effect at the time the data was downloaded, avoiding versioning problems. Any mismatch of versioning between the data and the visual is avoided because the cache caches the data as it was rendered on the screen in response to a previous request. The content of the screen display is captured, converted into its visual form and saved in storage. That is, the data that is cached includes the graphical representation of the user interface at a specific time instead of just caching the data and re-processing the data to generate what is displayed on the screen.

The subject matter described herein can replace the use of a throbber. Instead of displaying an animated image while information is being loaded, a stored image rendered from the most recently loaded content can be displayed while the current content is loaded (e.g., potentially in background). The subject matter described herein provides meaningful information on the display while the current information is being fetched from the server. The subject matter described herein can use a stored representation of the most recently rendered HTML to display an image that can display while loading the most current image.

In accordance with aspects of the subject matter described herein, the above described can be accomplished using JavaScript and HTML5. JavaScript is code that is executed inside of a browser. The JavaScript code receives information from the server, deserializes the data, manipulates the data using objects and creates HTML elements. The user sees the result of how the HTML renders the data. After the HTML as modified by the scripting language has processed the data, a graphical representation of the user interface can be captured, The graphical representation can be saved, for example, as a Base64 image in the HTML5 LocalStorage. Alternatively, the image can be saved in any appropriate client side persistent storage. Once saved, the next time the information is required, before even doing the call to the server, the image can be retrieved from storage and can be used as a placeholder while the server call is made to refresh the data and/or get a new rendering. When the more current (most recently downloaded) data is ready to display, the image can be swapped with (replaced by) the more current HTML-rendered image and the more current copy can be stored in local storage, replacing the previously stored image, thus ensuring that the stored image is as current as possible. Although described within the context of a single web “session”, it will be appreciated that the subject matter described below can also apply over multiple web sessions.

Web Caching with Image and Local Storage

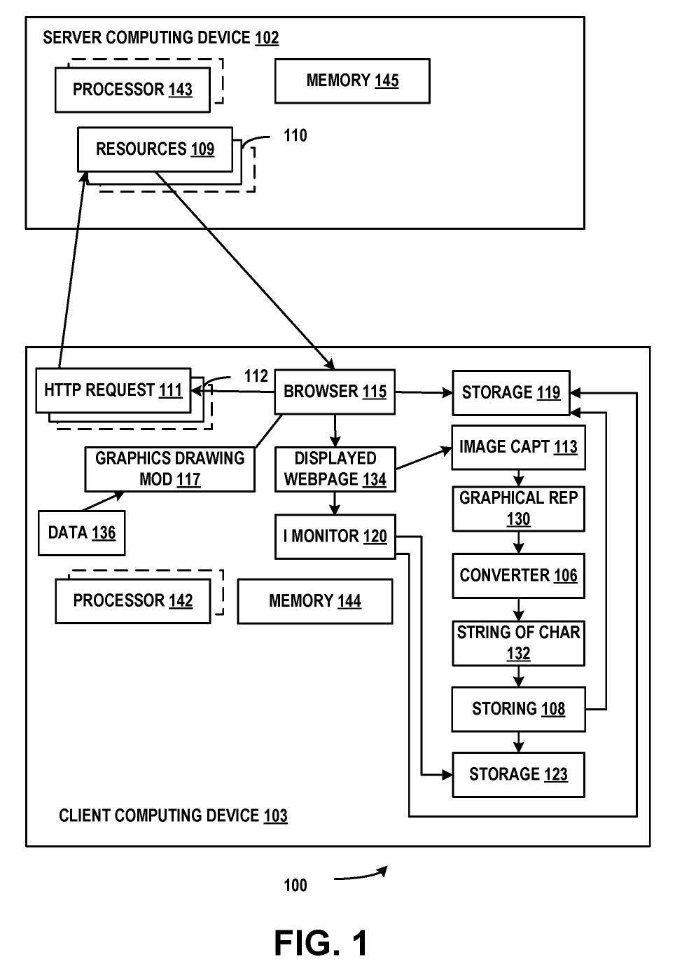

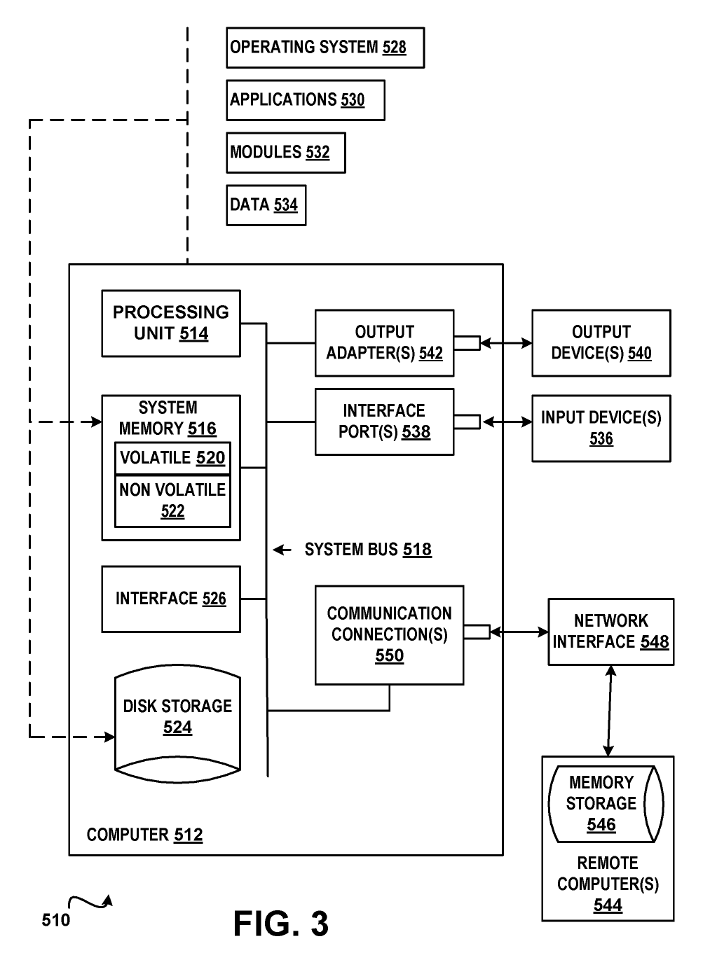

FIG. 1 is a block diagram 100 representing an example of a system for web caching in accordance with aspects of the subject matter described herein. All or portions of system 100 may reside on one or more computers or computing devices such as the computers described below with respect to FIG. 3. System 100 or portions thereof may be provided as a stand-alone system or as a plug-in or add-in.

System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 100 can include one or more computing devices such as, for example, computing device 102 and/or computing device 103. Contemplated computing devices include but are not limited to desktop computers, tablet computers, laptop computers, notebook computers, personal digital assistants, smart phones, cellular telephones, mobile telephones, servers, virtual machines, devices including databases, firewalls and so on. A computing device such as computing device 102 can include one or more processors such as processor 143, etc., and a memory such as memory 145 that communicates with the one or more processors. A computing device such as computing device 103 can include one or more processors such as processor 142, etc., and a memory such as memory 144 that communicates with the one or more processors.

System 100 may include one or more of a computing device 102 and/or one or more of a computing device 103. Computing device 102 can be a server. Computing device 102 can include one or more resources such as resource 109, resource 110, etc. Computing device 103 can be a client device. Client computing device 103 can include any one of or any combination of program modules comprising: a browser such as browser 115, a program module such as image-capturing module 113 that creates a graphical representation of at least a portion of a user interface (e.g., web page) as it is rendered at a point in time such as graphical representation 130, a program module such as graphics drawing program module 117 that can create a web page element that can be used to generate graphics, on the fly (dynamically), via scripting, a program module or modules such as converter 106 that converts or transforms a graphical representation 130 (e.g., an image or other webpage element) to a string of characters (e.g., string of characters 132) or vice versa, a program module or modules such as storing module 108 that stores the string of characters 132 in local storage such as storage 119 or storage 123, a program module or modules such as image monitor 120 that when a subsequent HTTP request is made, checks in local storage (e.g., storage 119 associated with the browser or other local storage such as storage 123) for the string of characters representing the graphical representation 130.

If it is present, converter 106 can convert the string of characters 132 back into the graphical representation 130. The graphical representation 130 can be displayed on a display device (not shown) of client computing device 103. Client computing device 103 may send one or more HTTP requests such as HTTP request 111, 112, etc. to a server computing device such as computing device 102. Examples of browsers include but are not limited to Firefox, Microsoft Corporation's Internet Explorer/Microsoft Edge, Google Chrome, Opera, and Safari. One non-limiting example of a graphics drawing module 117 can be but is not limited to a feature of HTML5 (that receives data such as data 136 that when rendered generates displayed webpage 134.

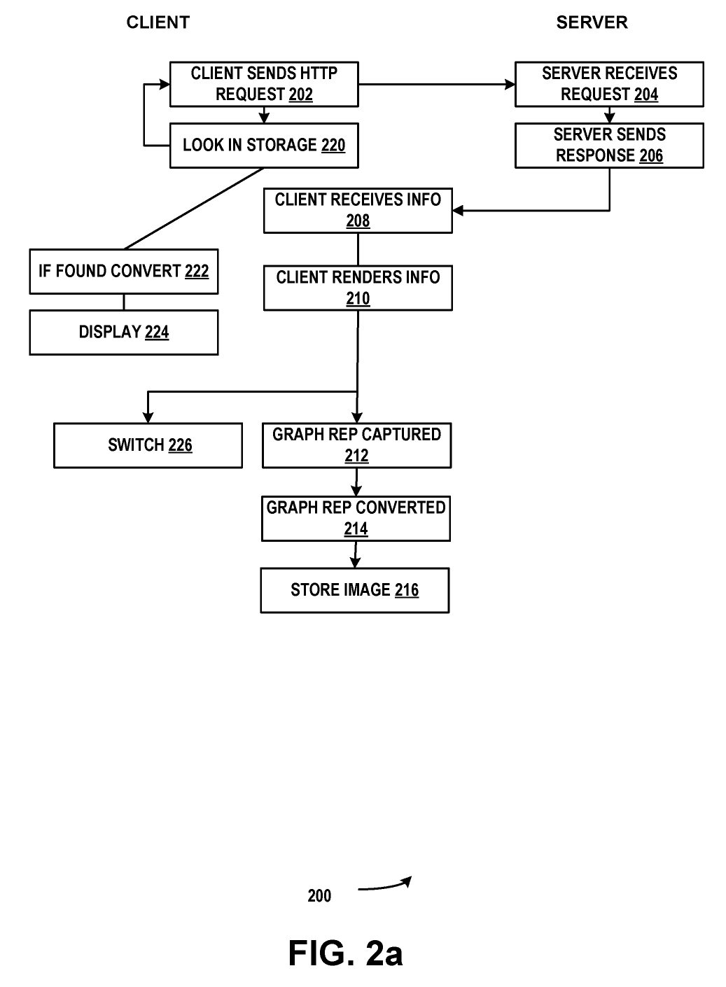

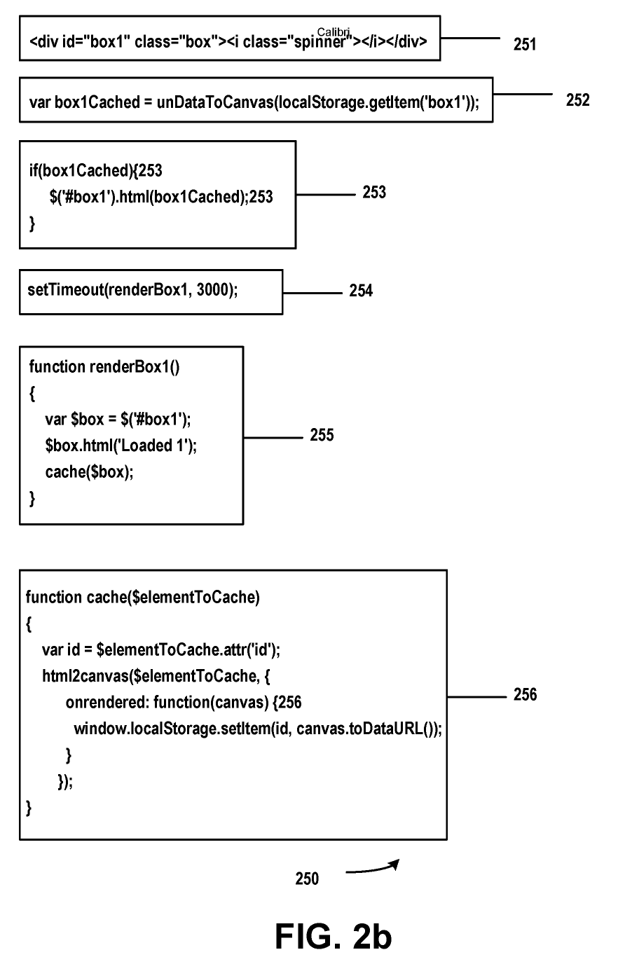

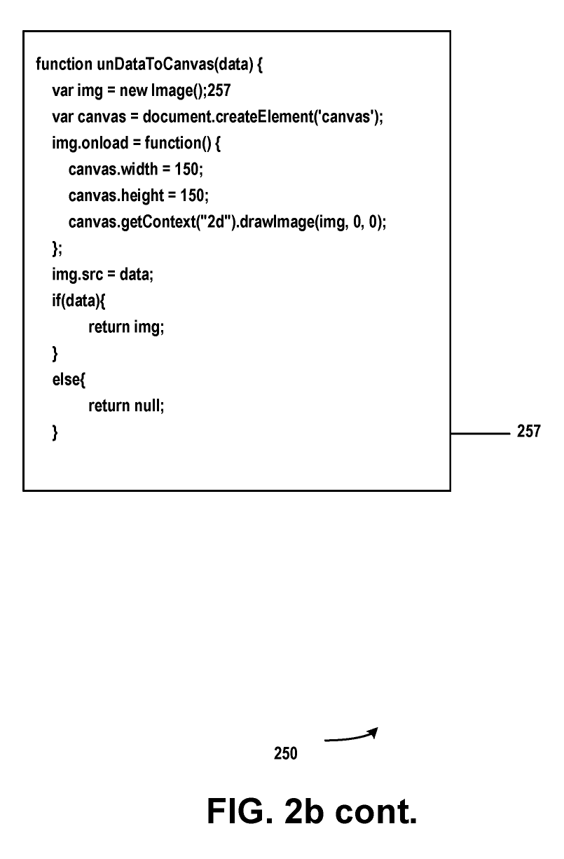

FIG. 2 illustrates an example of a method 200 for web caching in accordance with aspects of the subject matter described herein. While method 200 describes a series of operations that are performed in a sequence, it is to be understood that method 200 is not limited by the order of the sequence depicted. For instance, some operations may occur in a different order than that described. In addition, one operation may occur concurrently with another operation. In some instances, not all operations described are performed. In some instances, not all operations performed are illustrated. Method 200 or portions thereof may be executed by a system or a portion of a system such as system 100.

In a first iteration at operation 202 a client device can send an HTTP request to a server device. The HTTP request can include information such as but not limited to: a query string that identifies resources to be displayed at client side. In response at operation 204 the server device can receive the request and retrieve the resource. At operation 206 the server device can send information from the resource to the client device. The information that the server sends to the client can include data and which can be operated upon at the client by scripting language (e.g., JavaScript) code that affects the presentation of the requested information on the client device. At operation 208 the client device can receive the information. At operation 210 the client device can render the information. The information can be rendered on the client side by a browser such as browser 115 of FIG. 1. After the content is rendered on the client side, in accordance with aspects of the subject matter described herein, a picture, that is, a graphical representation of the user interface as rendered on the screen of the client device can be taken at operation 212 by an image-capturing module such as image capturing module 113,. The graphical representation can be a portion of the webpage.

At operation 214 the graphical representation (e.g., image) can be converted to a string of characters. At operation 216 the string of characters can be stored in local storage by a storing module such as storing module 108. The local storage can be the storage associated with the browser (e.g., storage 119). Alternatively, the string of characters can be stored somewhere else on the client such as, for example, in storage 123. Suppose now the page is refreshed or a section of the page is loaded asynchronously. Instead of experiencing a delay while an HTTP request was sent to the server and the response received at the client, the most recently downloaded, stored graphical representation can he displayed almost instantaneously, operation 220 just before the page is refreshed, the local storage can be examined by a module such as image monitor 120 and if at operation 222 the string of characters representing the graphical representation for the webpage is found in local storage such as storage 119 or storage 123, the string of characters can be converted back to a graphical representation at operation 214 by converter 106.

The graphical representation can be displayed on the display device at operation 224. Meanwhile a second HTTP request can be made potentially in background at operation 202. The server can receive the request at 204, send the response to the client at operation 206. The client can receive the information at operation 208, render it at operation 210, and replace at operation 226 the currently displayed graphical representation with the more current information rendered at operation 210. The second HTTP request may result in getting more current information. The more current information can be rendered and is made to the server. At operation 212 the new graphical representation can be captured, converted at operation 214 to a string of characters and stored at operation 216, thereby storing the most current information. The graphical representation stored as a string of characters is thus temporarily visible to the user for fast rendering and is replaced with a more current graphical representation (the most recently downloaded data as rendered by the code in effect at the time the data was downloaded) when the more current data becomes available.

FIG. 2b is an example 250 of pseudo code in accordance with aspects of the subject matter described herein. Statement 251 comprises HTML that includes one box. It will be appreciated that the HTML can include as many boxes as are need. Each box presents a space in the HTML that may need to be rendered. At the first load (in response to the first HTTP request, there is no stored image data so a spinner (throbber) can be displayed. The next section of code represents JavaScript. The JavaScript code attempts to get the cached data for the box from the local storage. In the first iteration, there will be no data because no data has been cached yet. Every further call will get data (e.g., an image as previously loaded). This is very fast. Even if there is cached data, a new request to the server is made to get fresh data 252. Statements 253 render each box. If there is data in the cache for this image, the image is rendered by the HTML.

The user will be able to see the image instead of the spinner. Statement 254 represents a long request to the server with a timeout.

In some instances the boxes will get the real data in seconds. Every call to the webpage after the first call will not display a spinner but instead will display the appropriate image. Even if there is a seconds delay on subsequent calls, the result of the call will be to swap the image to more current data and to update the cache, keeping the cache as up to date as possible and to allow the user to interact with the HTML not the image. Section of code 255 describes what happens once the data for each box is received from the server. The HTML is replaced with the most recently received HTML from the server, allowing the user to interact with the HTML from the server (e.g., button, link, etc.). The cache can be updated with the most recently downloaded information for subsequent calls. In section of code 256 the cache receives the content of the box, creates an image and saves the image into the local storage. Section of code 257 allows subsequent calls to unwrap the data into an image. The method creates an image and draws the cached version of the image.

### Conclusion

Described herein is a computing device comprising at least one processor, a memory connected to the at least one processor and at least one program module that when loaded into the memory causes the at least one processor to store a markup language element in local storage on a client computing device so that subsequent access to the stored element is almost instantaneous. The stored markup language element can be a graphical markup language element. The graphical markup language element can be converted to a string of characters. The stored graphical representation can be displayed while more current information from a server computing device is retrieved. The stored graphical representation can be the most recently loaded content. The stored animated image can be while current content is loaded in background. Client side script can be used to create the graphical representation stored in the markup language element. The graphical representation can be replaced by current content. Described herein is a method of web caching comprising the operations of: receiving by a processor of a client computing device in response to a first HTTP request an HTTP response comprising an element of a webpage, storing a representation of a graphical representation of the element of a webpage in local storage, in response to issuing a second HTTP request, converting the stored representation of the graphical representation in storage, and displaying the graphical representation while a second HTTP request is being processed. The graphical representation can be converted to a string of characters. The string of characters can be stored in local storage. Local storage can be examined for the string of characters representing the graphical representation. The graphical representation can be displayed until more current data is received. The graphical representation can be swapped with a more current graphical representation. The graphical representation can be used as a spinner. The most recently downloaded data can be stored as an image. Described herein is a computing device comprising at least one processor, a memory connected to the at least one processor and at least one program module that when loaded into the memory causes the at least one processor to: receive in response to an HTTP request an HTTP response comprising an image, the image comprising a portion of a webpage, store a representation of the image in local storage, in response to issuing a second HTTP request, convert the stored representation of the image into the image; and display the image while the second HTTP request is being processed. The cached data can be displayed as the data was displayed with previously-rendering code. The image can be stored. The stored image can be displayed while the second HTTP request is processed. The displayed image can be replaced with a more current image.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above.

Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computing device comprising:
at least one processor:
a memory connected to the at least one processor; and
at least one program module that when loaded into the memory causes the at least one processor to:
store a markup language element in local storage on a client computing device so that subsequent access to the stored element is almost instantaneous.

2. The computing device of claim 1, further comprising:
wherein the stored markup language element is a graphical markup language element.

3. The computing device of claim 2, further comprising:
at least one program module that:
converts the graphical markup language element to a string of characters.

4. The computing device of claim 1, further comprising:
at least one program module that:
displays a stored graphical representation while more current information from a server computing device is retrieved.

5. The computing device of claim 4, further comprising:
at least one program module that:
displays the stored graphical representation, the stored graphical representation comprising most recently loaded content.

6. The computing device of claim 5, further comprising:
at least one program module that:
displays the stored animated image while current content is loaded in background.

7. The computing device of claim 1, further comprising:
at least one program module that:
uses client side script to create the graphical representation stored in the markup language element.

8. The computing device of claim 6, wherein the graphical representation is replaced by current content.

9. A method of web caching comprising:
receiving by a processor of a client computing device in response to a first HTTP request an HTTP response comprising an element of a webpage;
storing a representation of a graphical representation of the element of a webpage in local storage: and
in response to issuing a second HTTP request, converting the stored representation of the graphical representation in storage; and
displaying the graphical representation while a second HTTP request is being processed.

10. The method of claim 9, further comprising:
converting the graphical representation to a string of characters.

11. The method of claim 10, further comprising:
storing the string of characters in local storage.

12. The method of claim 9, further comprising:
examining the local storage for the string of characters representing the graphical representation.

13. The method of claim 9, further comprising:
displaying the stored graphical representation until more current data is received.

14. The method of claim 13, further comprising:
replacing the graphical representation with a more current graphical representation.

15. The method of claim 9, further comprising:
storing the more current graphical representation.

16. A computing device comprising:
at least one processor:
a memory connected to the at least one processor; and
at least one program module that when loaded into the memory causes the at least one processor to:
receive in response to an HTTP request an HTTP response comprising an image, the image comprising a portion of a webpage;
store a representation of the image in local storage;
in response to issuing a second HTTP request, convert the stored representation of the image into the image; and
display the image while the second HTTP request is being processed.

17. The computing device of claim 16, wherein:
the cached data is displayed as the data was displayed with previously-rendering code.

18. The computing device of claim 16, further comprising:
a program module that:
stores the image, the image comprising a spinner.

19. The computing device of claim 16 further comprising :
a program module that:
displays the stored image while the second HTTP request is processed.

20. The computing device of claim 16 further comprising :
a program module that:
replaces the displayed image with a more current image.
